(19) United States
(12) Patent Application Publication
(10) Pub. No.: US 2008/0123505 A1
(43) Pub. Date: May 29, 2008

(54) OPTICAL DISK APPARATUS AND OPTICAL DISK REPRODUCTION METHOD

(75) Inventors: Nobuyuki BABA, Kawasaki-shi (JP); Kazumi SUGIYAMA, Kawasaki-shi (JP); Yoshinori TAZAKI, Yokohama-shi (JP); Yuuichi SHIGEMATSU, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/854,009

(22) Filed: Sep. 12, 2007

(30) Foreign Application Priority Data
Nov. 28, 2006 (JP) 2006-319964

(51) Int. Cl. G11B 3/74

(52) U.S. Cl. 369/94

(57) ABSTRACT

According to one embodiment, here is provided an optical disk apparatus including: a reading unit configured to read an address corresponding to a position of beam spot; a calculating unit configured to calculate, from the address corresponding to the position of beam spot, a seeking amount in making an access to a burst cutting area formed on a disk; and a movement unit configured to move the position of beam spot in accordance with the seeking amount calculated by the calculating unit.

### CROSS-REFERENCE TO RELATED APPLICATIONS

This application is based upon and claims the benefit of priority from Japanese Patent Application No. 2006-319964, filed on Nov. 28, 2006, the entire contents of which are incorporated herein by reference.

### BACKGROUND

1. Field

One embodiment of the invention relates to an optical disk apparatus and an optical disk reproduction method, and more particularly, to an optical disk apparatus and an optical disk reproduction method which can access to a burst cutting area (BCA).

2. Description of the Related Art

In order to prevent unauthorized duplication of a disk, copyright protection techniques; for example, CPPM (Content Protection for Prerecorded Media), CPRM (Content Protection for Recordable Media), and the like, have recently been adopted by various DVD standards such as DVD (Digital Versatile Disk)-ROM, a DVD-RW, and the like.

In relation to these copyright protection techniques, a BCA (Burst Cutting Area) is generally provided at a predetermined location (e.g., a position on the innermost track or the like) on a disk. This BCA is an area where bar-code-like record data are created by forming recording marks in a radial pattern according to, e.g., a recording scheme for burning off a recording layer. An MKB (Media Key Block), a media ID, and others, are recorded in the BCA.

In the case of reproduction of a DVD whose copyright is protected by, e.g., CPRM among the copyright protection techniques, an access is first made to the BCA provided at a predetermined position on the disk, to thus perform reading operation. A media key is created by a read MKB and a device key of a player, and an encryption key is created by the media ID read from the BCA and the media key. Next, after contents data recorded in the disk have been decoded by the thus-created encryption key according to a predetermined scheme, the decoded contents data are reproduced.

It is disclosed by, for example JP-A-2006-85764, that a technique for determining, by a pull-in signal at the time of seeking of a BCA, whether or not the BCA has been reached has been proposed as a technique for making an access to the BCA provided at the predetermined position on the disk.

According to the technique disclosed in JP-A-2006-85764, a determination is made, by a pull-in signal at the time of seeking of a BCA, as to whether or not the BCA has been reached. Hence, a position sensor for determining whether or not the BCA has been reached becomes obviated, and the BCA can be reliably sought without recourse to counting the number of steps of a stepping motor.

However, according to the technique disclosed in JP-A-2006-85764, a determination is made, by a pull-in signal at the time of seeking of a BCA, as to whether or not the BCA has been reached. Accordingly, the BCA can be reliably sought without the help of counting the number of steps of a stepping motor. However, an access is made to the BCA by performing gradual seeking from an outer track toward an inner track, which raises an access to a BCA involving consumption of much time.

Especially, in the case of a multilayer DVD (e.g., a two-layer DVD or the like), a BCA is generally disposed at a position on a disk closest to a label plane. However, because of a plurality of layers in the disk, it takes a much longer time to access to the BCA.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the internal configuration of an optical disk drive according to a first embodiment of the invention;

FIG. 2 is an exemplary descriptive view for describing the structure of a BCA area provided on an optical disk;

FIG. 3 is an exemplary flowchart for describing BCA read processing performed in the optical disk drive shown in FIG. 1;

FIG. 4 is an exemplary descriptive view for describing a positional relationship of the BCA provided on the optical disk; and

FIG. 5 is an exemplary flowchart for describing another BCA read processing performed in the optical disk drive shown in FIG. 1.

### DETAILED DESCRIPTION

Various embodiments according to the invention will be described hereinafter with reference to the accompanying drawings. In general, according to one embodiment of the invention, there is provided an optical disk apparatus including: a reading unit configured to read an address corresponding to a position of beam spot; a calculating unit configured to calculate, from the address corresponding to the position of beam spot, a seeking amount in making an access to a burst cutting area formed on a disk; and a movement unit configured to move the position of beam spot in accordance with the seeking amount calculated by the calculating unit.

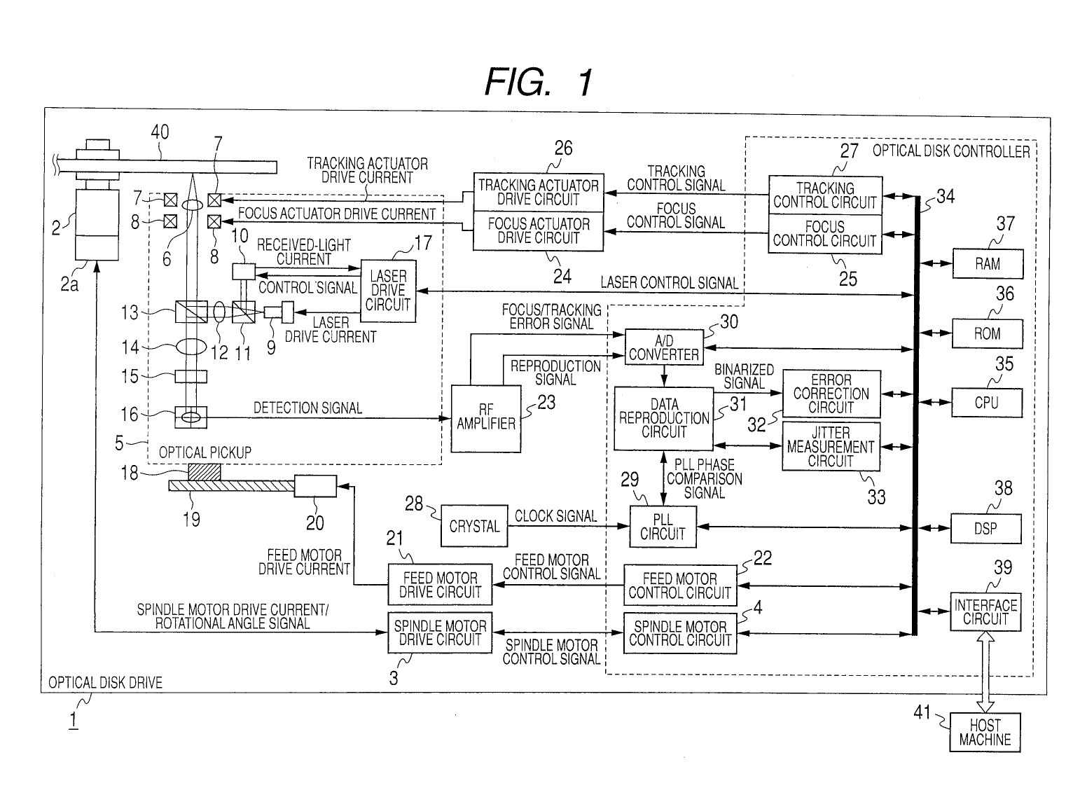

According to an embodiment, FIG. 1 shows internal configuration of an optical disk drive 1.

The optical disk drive 1 records and reproduces information on and from an optical disk 40, such as a DVD (Digital Versatile Disc), serving as an information recording medium. Grooves are concentrically or helically inscribed in the optical disk 40. Recess portions of the groove are called lands, and protruding portions of the groove are called grooves. A circular path formed by the grooves or the lands is called a track. A laser beam of modulated intensity is radiated along the track (including only grooves or of the grooves and the lands), to thus create a recording mark, whereby user data are recorded on the optical disk 40. Data are reproduced by irradiating the track with a laser beam of reading power (Reproducing Power), which is lower than the power used for recording; and detecting variations in the intensity of light reflected from the recording mark provided in the track. The recorded data are erased by irradiating the track with a laser beam of erase power, which is higher than the reading power, thereby crystallizing the recording layer.

The optical disk 40 is rotationally driven by a spindle motor 2. A rotation angle signal is output from an accompanying rotary encoder 2a of the spindle motor 2 to a spindle motor drive circuit 3. When the spindle motor 2 rotates once, five pulses, for instance, are generated as a rotation angle signal. As a result, a spindle motor control circuit 4 can determine the rotational angle and the number of rotations of the spindle motor 2 from the rotation angle signal input by the rotary encoder 2a by a spindle motor drive circuit 3. The spindle motor 2 is controlled by the spindle motor control circuit 4.

Information is recorded on or reproduced from the optical disk 40 by an optical pickup 5. The optical pickup 5 is coupled to a feed motor 20 by a gear 18 and a screw shaft 19. The feed motor 20 is controlled by a feed motor drive circuit 21. When the motor 20 is rotated by a feed motor drive current supplied by a feed motor drive circuit 21, the optical pickup 5 is moved in the radial direction of the optical disk 40.

The optical pickup 5 is provided with an objective lens 6 supported by an unillustrated wire or leaf spring. The objective lens 6 can be moved in a focusing direction (the direction of the optical axis of the lens) by driving operation of a focus actuator 8. The objective lens 6 can also be moved in a tracking direction (a direction orthogonal to the optical axis of the lens) by driving operation of a tracking actuator 7.

At the time of recording of information (at the time of creation of a mark), a laser drive circuit 17 performs modulation according to a predetermined modulation scheme [e.g., an 8-14 modulation (EFM: Eight Fourteen Modulation) scheme or the like] and in accordance with the record data supplied by a host machine 41 by an interface circuit 39; generates a write signal from the modulated data; and supplies a laser diode (a laser-emitting element) 9 with the thus-generated write signal. At the time of reading of information, the laser drive circuit 17 supplies the laser diode 9 with a read signal which is lower in power than the write signal.

A front monitor photodiode 10 bifurcates a portion of the laser beam generated by the laser diode 9 at only a given ratio by a half mirror 11; detects a received-light signal proportional to the quantity of light or radiation power; and supplies the detected received-light signal to the laser drive circuit 17. The laser drive circuit 17 acquires the received-light signal supplied by the front monitor photodiode 10, and controls the laser diode 9 in accordance with the thus-acquired received-light signal in such a way that light is emitted at reproducing laser power (radiation power), recording laser power, or erase laser power which have been previously set by the CPU 35.

The laser diode 9 emits a laser beam in response to a signal supplied by the laser drive circuit 17. The optical disk 40 is irradiated with the laser beam emitted by the laser diode 9 by a collimator lens 12, a half prism 13, and the objective lens 6. The light reflected from the optical disk 40 is guided to a photodetector 16 by the objective lens 6, the half prism 13, a condenser lens 14, and a cylindrical lens 15.

The photodetector 16 is formed from, e.g., a quadrant photodetector cell; generates a detection signal; and outputs the thus-generated detection signal to an RF amplifier 23. The RF amplifier 23 processes the detection signal from the photodetector 16, to thus generate a focus error (FE) signal showing a deviation from focus, a tracking error (TE) signal showing a deviation between the beam spot center of the laser beam and the center of a track, and a reproduction (RF) signal corresponding to a total addition of detection signals; and supplies an A/D converter 30 with the thus-generated focus error (FE) signal, the tracking error (TE) signal, and the reproduction (RF) signal.

In accordance with the focus error (FE) signal from an RF amplifier 23 captured by a DSP 38 via the A/D converter 30, a focus control circuit 25 generates a focus control signal, and supplies a focus actuator drive circuit 24 with the thus-generated focus control signal. In accordance with the focus control signal supplied by the focus control circuit 25, the focus actuator drive circuit 24 supplies the focus actuator 8 with a focus actuator drive current for actuating the focus actuator 8 in a focusing direction. Thus, there is performed focusing servo operation by which the laser beam comes into focus on the recording film of the optical disk 40 at all times.

In accordance with the tracking error (TE) signal from the RF amplifier 23 captured by the DSP 38 by the A/D converter 30, a track control circuit 27 generates a track control signal, and supplies a tracking actuator drive circuit 26 with the thus-generated track control signal. In accordance with the tracking control signal supplied by the tracking control circuit 27, the tracking actuator drive circuit 26 supplies the tracking actuator 7 with a tracking actuator drive current for actuating the tracking actuator 7 in a tracking direction. Thus, there is performed tracking servo operation by which the laser beam traces (follows) the track formed on the optical disk 40 at all times.

As a result of such focusing servo operation and tracking servo operation being performed, changes in the light reflected from pits, which are formed in the track of the optical disk 40 in response to recording information, are reflected on a reproduction (RF) signal corresponding to a total sum of detection signals from the photodetector 16 (the respective photodetector cells). This reproduction signal is supplied to a data reproduction circuit 31 by the A/D converter 30. The data reproduction circuit 31 generates a binarized signal of one or zero in accordance with the reproduction signal supplied by the A/D converter 30, and the thus-generated binarized signal is output to an error correction circuit 32. Moreover, upon outputting the binarized signal to the error correction circuit 32, the data reproduction circuit 31 generates, as a PLL phase comparison signal, a phase difference between a reproduction clock signal supplied by a PLL (Phase-Locked Loop) circuit 29 and the binarized signal; and outputs the thus-generated PLL phase comparison signal to the PLL circuit 29.

In accordance with the reproduction signal supplied by the A/D converter 30 and the reproduction clock signal generated by the PLL circuit 29, a jitter measurement circuit 33 measures a jitter of the reproduction signal. A CPU 35 can read the thus-measured jitter measurement signal by a bus 34.

The DSP (Digital Signal Processor) 38 subjects, to various arithmetical processing operations, digital signals such as the focus error (FE) signal, the tracking error (TE) signal, and the like which are converted into digital signals by the A/D converter 30 after having been output from the RF amplifier 23, thereby controlling the spindle motor control circuit 4, a feed motor control circuit 22, the focus control circuit 25, and the tracking control circuit 27.

The DSP 38 controls the spindle motor control circuit 4, the feed motor control circuit 22, the focus control circuit 25, and the tracking control circuit 27 by the bus 34.

Moreover, the laser drive circuit 17, the PLL circuit 29, the A/D converter 30, the error correction circuit 32, the jitter measurement circuit 33, and the DSP 38 are controlled by the CPU (Central Processing Unit) 35 by the bus 34. The CPU 35 complies with an operation command supplied by the host machine 41 by the interface circuit 39; performs various processing operations in accordance with a program stored in ROM (Read Only Memory) 36 or a program loaded from the ROM 36 into RAM (Random Access Memory) 37, to thus generate various control signals; and supplies respective sections with the thus-generated control signals, thereby collectively controlling the optical disk drive 1.

Incidentally, according to the technique disclosed in JP-A-2006-85764, a determination is made, from a pull-in signal at the time of seeking of a BCA, as to whether or not the BCA has been reached. Accordingly, seeking of the BCA can be reliably performed without recourse to counting of the number of steps of a stepping motor. However, seeking is gradually performed from an outer track toward an inner track, to thus make an access to the BCA. Therefore, it takes a much longer time to make an access to the BCA.

Especially, in the case of the multilayer optical disk 40 (e.g., the two-layer optical disk 40 or the like), a BCA is generally disposed at a position on a disk [a second-layer disk (L1) in the case of, e.g., a two-layer optical disk 40] closest to a label plane. However, because of a plurality of layers in the disk, making an access to a BCA involves consumption of a much longer time. A disk (L0) of the first layer is defined as a disk provided at the lowest layer in the optical disk 40. A disk of closest to the surface of the optical disk 40 comes to the second-layer disk (L1). In the case of a three-layer optical disk 40, the first-layer disk, the second-layer disk, and the third-layer disk are sequentially affixed together, and the disk closest to the surface of the optical disk 40 comes into the third-layer disk.

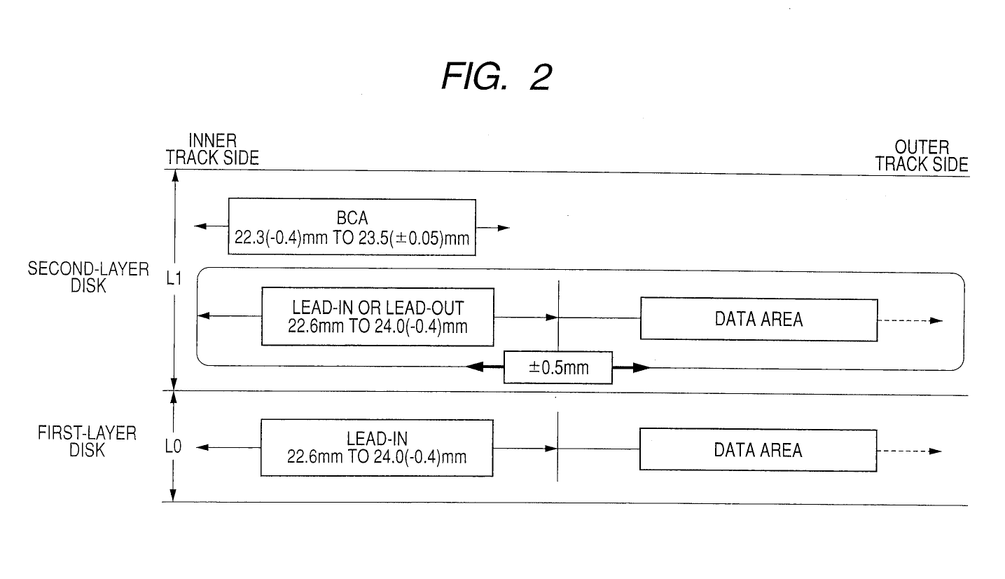

In the case of the optical disk 40 having two layers on one side or on both sides thereof, a deviation between the disks arising in the process of affixing the first-layer disk (L0) to the second-layer disk (L1) is allowed to have a value of ±0.5 mm as shown in FIG. 2. In contrast with the optical disk 40 formed by a single layer, it takes a much longer time to make an access to the BCA in case that the multi-layer disks would be possibly out of alignment when the multi-layer disks are affixed together.

As general standards, a range where a BCA is to be provided is allowed to deviate from 22.3 to 23.5 mm with reference to the center position of the optical disk 40 as shown in FIG. 2. The range is allowed to deviate toward an outer track (by an amount of ±0.05 mm) as well as toward an inner track (by an amount of −0.4 mm).

In the multilayer optical disk 40, a predetermined relative relationship exists between the position of a BCA provided on a disk closest to the surface of the optical disk [i.e., the second-layer disk (L1) in the case of, e.g., a two-layer optical disk 40] and the position of a disk provided at the lowest layer in the optical disk 40 [i.e., the first-layer disk (L0) in the case of, e.g., the two-layer optical disk 40]. Hence, the amount of seeking operation performed in making an access from the current position to the BCA is calculated from the relative positional relationship and the current position where focus is achieved, and an access is made to the BCA according to a result of computation. A quick, accurate access can be made to the BCA. BCA reading operation of the optical disk drive 1 shown in FIG. 1 that uses the method will be described hereunder.

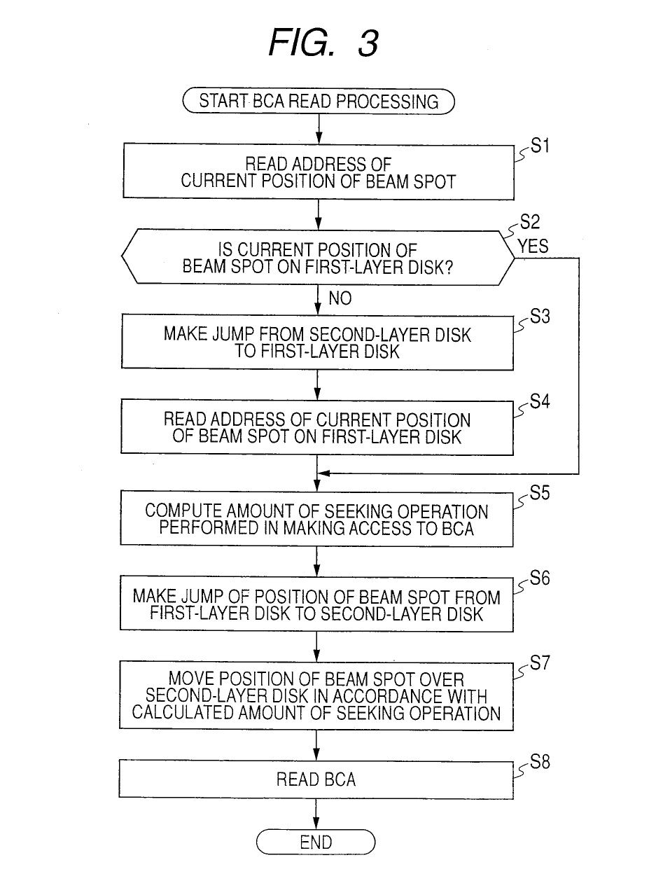

BCA reading operation of the optical disk drive 1 shown in FIG. 1 will now be described by reference to the flowchart shown in FIG. 3. BCA reading operation is commenced when a command for initiating reproduction processing is issued as a result of a user having operated an unillustrated operation section of the host machine 41 after the optical disk 40 has been inserted into a predetermined position of the optical disk drive 1.

In order to make explanations simple, the embodiment is applied to the two-layer optical disk consisting of the first-layer disk and the second-layer disk. However, the embodiment may also be applied to a multilayer optical disk of three or more layers.

In step S1, the CPU 35 controls the optical pickup 5, to thus cause the laser diode 9 to radiate a laser beam on the optical disk 40. Thus, an address (a sector address) of the current position of a beam spot is read.

In step S2, the CPU 35 determines, from the thus-read address (sector address) of the current position of the beam spot, whether or not the current position is on the first-layer disk. When in step S2 the current position has been determined not to be on the first-layer disk (i.e., when the current position has been determined to be on the second-layer disk), in step S3 the CPU 35 controls the optical pickup 5, the focus control circuit 25, and the tracking control circuit 27, and causes the position of the beam spot to jump from the second-layer disk to the first-layer disk (moves the position of the beam spot to a disk of another layer).

Next, in step S4, the CPU 35 controls the optical pickup 5, to thus cause the laser diode 9 to radiate a laser beam on the optical disk 40. Thus, an address (a sector address) of the current position of a beam spot on the first-layer disk is read.

Meanwhile, when in step S2 the current position of the beam spot has been determined to be on the first-layer disk, processing pertaining to steps S3 and S4 is skipped. As a result, jump processing pertaining to step S3 is not performed.

In step S5, the CPU 35 computes, from the address of the current position of the beam spot, the amount of seeking operation performed in making an access from the current position of the beam spot to the BCA by a relative positional relationship between the position of the BCA disposed on the second-layer disk and the first-layer disk.

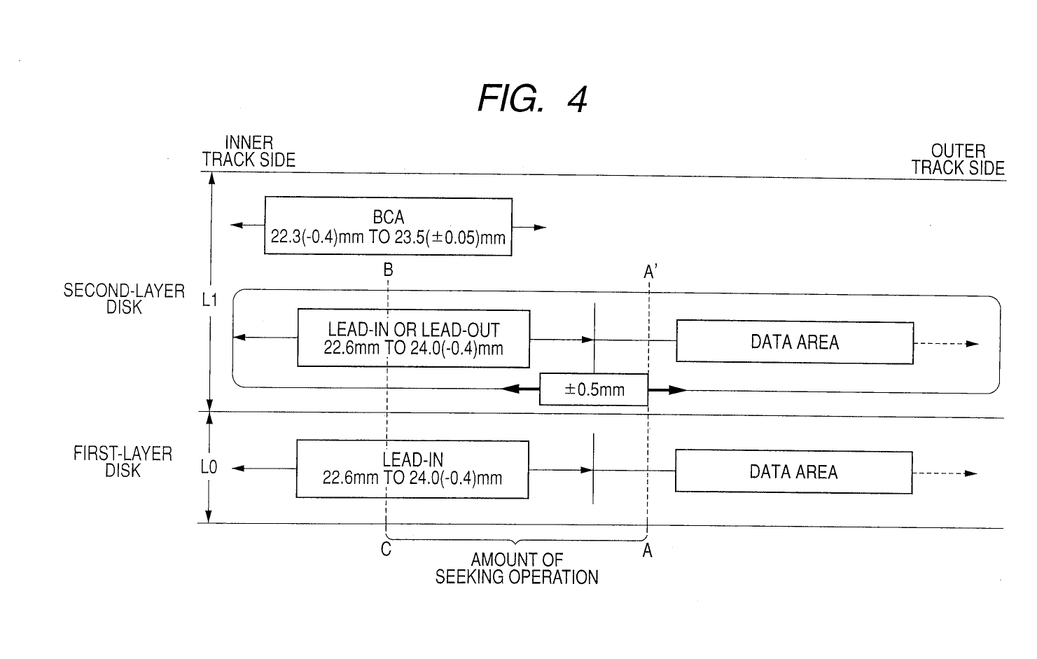

Specifically, as shown in FIG. 4, the center position B of the BCA disposed on, e.g., the second-layer disk (L1), exhibits a relative positional relationship of being located at a predetermined position C on the first-layer disk (L0). Hence, when the current position of the beam spot corresponds to location A on the first-layer disk (L0), the amount of seeking operation performed in making an access from the current position A of the beam spot to position C is calculated from an address of the current position A of the beam spot and an address of position C. The thus-calculated amount of seeking operation performed in making an access from the current position A of the beam spot to position C is taken as the amount of seeking operation performed in making an access from the current position A of the beam spot to the BCA.

For instance, when the BCA is disposed within a range from 22.3 mm to 23.5 mm with reference to the center position of the optical disk 40, the center position B of the BCA is separated from the center position of the optical disk 40 by 22.9 mm. Hence, when the current position of the beam spot corresponds to position A on the first-layer disk (L0) and when the position A is separated from the center position of the optical disk 40 by 27.0 mm, the amount of seeking operation performed in making an access from the current position A of the beam spot to position C is calculated as 4.1 mm=27.0 mm−22.9 mm. The thus-calculated amount of seeking operation (4.1 mm) performed in making an access from the current position A of the beam spot to the position C is calculated as the amount of seeking operation performed in making an access from the current position A of the beam spot to the BCA (the center position of the BCA).

The location to be accessed is not limited to the center position of the BCA, and the amount of seeking operation may also be calculated so as to make an access to any location of the BCA. For instance, the amount of seeking operation may also be calculated so as to make an access to a position deviating toward an inner track by only a quarter distance from the center position of the BCA.

In step S6, the CPU 35 controls the optical pickup 5, the focus control circuit 25, the tracking control circuit 27, and the like; and causes the position of the beam spot to jump from the first-layer disk to the second-layer disk.

For instance, in the case illustrated in FIG. 4, the position of the beam spot is caused to jump from the position A on the first-layer disk to position A′ (a position located immediately above the position A on the first-layer disk) on the second-layer disk (i.e., the position of the beam spot is moved to another layer).

In step S7, the CPU 35 controls the optical pickup 5 and the feed motor control circuit 22, and moves the position of the beam spot over the second-layer disk in accordance with the calculated amount of seeking operation (i.e., the amount of seeking operation performed in making an access from the current position of the BCA).

For instance, in the case illustrated in FIG. 4, the position of the beam spot is moved from the position A′ to the position B (the center position of the BCA) in accordance with the calculated amount seeking operation (i.e., the amount of seeking operation performed in making an access from the current position of the beam spot to the BCA). The distance between the positions A and C is considered to be substantially equal to a distance between the positions A′ and B. Therefore, the position of the beam spot can be moved from the position A′ to the position B (the center position of the BCA) by the amount of seeking operation (the amount of seeking operation performed in making an access from the current position of the beam spot to the BCA) calculated in accordance with the address of the position A and the address of the position C.

In relation to BCA reading operation pertaining to step S8 to be described later, a signal is formed on the premise that a signal is read in an off-tracking state at the time of reading of a BCA. So long as the beam spot is located in any area within the range of the BCA, an MKB and a media ID which are recorded in the BCA can be read.

As a result, a quick, accurate access can be made to the BCA. For instance, a quick, accurate access can be made to the center position of the BCA. Moreover, since a necessity for gradual seeking of a BCA is obviated, a direct access, for instance, can be made to the center position of the BCA.

In step S8, the CPU 35 reads the BCA where the beam spot is located. Specifically, the MKB and the media ID which are previously recorded in the BCA are read. Thereby, when processing for reproducing content data recorded in the optical disk 40 is performed, a media key is created by the read MKB and a device key of the player, and an encryption key is created by the media ID read from the BCA and this media key. Next, after the content data recorded in the disk have been decoded by the created encryption key according to a predetermined scheme, the decoded content data are reproduced.

In the embodiment, an address of the current position of the beam spot is read, and, from the thus-read address, a determination is made as to whether or not the current position of the beam spot is located on the first-layer disk. When the current position of the beam spot has been determined to be located on the first-layer disk, the amount of seeking operation performed in making an access from the current position of the beam spot to the BCA can be calculated by a relative positional relationship between the position of the BCA (e.g., the center position of the BCA) provided on the second-layer disk and the first-layer disk and in accordance with the address of the current position of the beam spot.

Meanwhile, when the current position of the beam spot has been determined not to be on the first-layer disk (i.e., when the current position of the beam spot has been determined to be on the second-layer disk), a jump is made from the second-layer disk to the first-layer disk. An address of the current position of the beam spot on the first-layer disk acquired after the jump is read. The amount of seeking operation performed in making an access from the current position of the beam spot to the BCA can be calculated by a relative positional relationship between the position of the BCA (e.g., the center position of the BCA) provided on the second-layer disk and the first-layer disk and in accordance with the address of the current position of the beam spot.

The position of the beam spot on the second-layer disk can be moved in accordance with the calculated amount of seeking operation (the amount of seeking operation performed in making an access from the current position of the beam spot to the BCA).

As a result, a quick, accurate access can be made to the BCA. For instance, a quick, accurate access can be made to the center position of the BCA. Since gradual seeking of the BCA is obviated, a direct access can be made to, for example, the center position of the BCA.

Particularly, even when a displacement (a displacement of ±0.5 mm) has arisen during the course of affixing the first-layer disk and the second-layer disk together, an accurate access can be made directly to the BCA without being affected by the displacement and in accordance with the amount of seeking operation calculated from the address of the first-layer disk. Consequently, there can be avoided occurrence of a problem, which would otherwise be caused when an access is made to the BCA with reference to the address of the second-layer disk for reasons of a radial displacement arising during the course of the first-layer disk and the second-layer disk being affixed together.

Even when a displacement which is permissible in terms of the standards of a BCA exists, the amount of seeking operation performed in making a direct access to, e.g., the center position of a BCA is calculated. Accordingly, there can be prevented occurrence of a situation where an access cannot be made to the BCA for reasons of a displacement that is derived from the displacement□being permissible in terms of the standards□and that falls in the range of the BCA. Thus, an access can be reliably made to the BCA.

Consequently, the optical disk drive 1 can quickly and accurately commence reproduction processing.

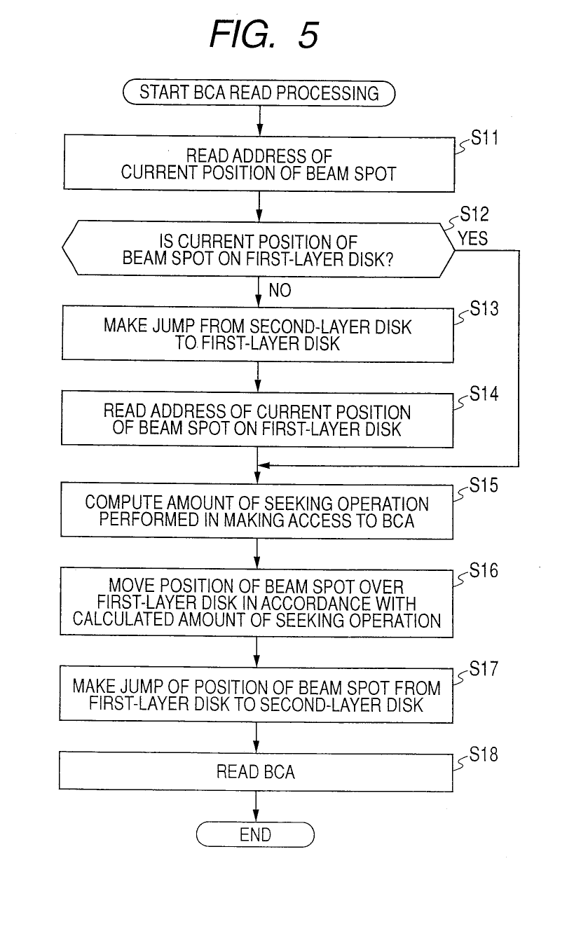

Incidentally, in the BCA reading operation described by reference to the flowchart of FIG. 3, in step S6, processing for making a jump from the first-layer disk to the second-layer disk is performed. Subsequently, the position of the beam spot is moved over the second-layer disk in accordance with the amount of seeking operation calculated in step S7, and an access is made to the BCA on the second-layer disk (i.e., the position is moved in sequence of A→A′→B, thereby making an access to the BCA on the second-layer disk). However, the embodiment is not limited to such processing. For instance, as shown in the flowchart of FIG. 5, the position of the beam spot on the first-layer disk is moved over the first-layer disk to a point located below the position where the BCA exists in accordance with the amount of seeking operation calculated in step S16. Subsequently, there may also be performed processing for making a jump from the first-layer disk to the second-layer disk (movement of the beam spot to another layer) (namely, an access may also be made to the BCA on the second-layer disk by making a jump in sequence of A→C→B)).

For example, in the case illustrated in FIG. 4, the position of the beam spot is moved from position A to position C (a position located below the center position of the BCA) in accordance with the calculated amount of seeking operation (the amount of seeking operation performed in making an access from the current position of the beam spot to the BCA). Subsequently, the position of the beam spot is jumped from position C to position B (the center position of the BCA) (the position of the beam spot is moved to another layer).

Processing pertaining to steps S11 through S18 in FIG. 5 is basically analogous to processing pertaining to steps S1 through S8 shown in FIG. 3, and their repeated explanations are omitted here for brevity.

The embodiment is not limited to a multi-layer optical disk, and may be applied to a single-layer optical disk 40.

In the embodiment, processing for computing the amount of seeking operation is performed by the CPU 35. However, in place of the CPU 35 the DSP 38 may perform processing.

Moreover, the embodiment is applied to a rewritable optical disk 40 such as a CD-RW, a DVD-RW, or the like. The embodiment may also be applied to a write-once optical disk 49, in which data can be recorded only once, such as a CD-R, a DVD-R, or the like. Alternatively, the embodiment may also be applied to a read-only optical disk 40 such as DVD-ROM or the like.

A series of processing operations described in connection with the embodiment can also be performed by hardware as well as by software.

In the embodiment, steps of the flowchart illustrate processing to be performed on the time series according to a described sequence. However, the steps include processing which is not performed on the time series but is performed in parallel or individually.

According to the above-described embodiment, a quick, accurate access can be made to a BCA. While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk apparatus comprising:
a reading unit configured to read an address corresponding to a position of beam spot;
a calculating unit configured to calculate, from the address corresponding to the position of beam spot, a seeking amount in making an access to a burst cutting area formed on a disk; and
a movement unit configured to move the position of beam spot in accordance with the seeking amount calculated by the calculating unit.

2. The optical disk apparatus according to claim 1, wherein the disk is a multilayer disk including a first layer and a layer different from the first layer,
wherein the beam spot is provided on the first layer of the multilayer disk, and
wherein the movement unit moves the position of the beam spot provided on the first layer to the layer different from the first layer after the movement unit moves the position of the beam spot in accordance with the seeking amount calculated by the calculating unit.

3. The optical disk apparatus according to claim 2, wherein the calculating unit calculates, from the address read by the reading unit, the seeking amount to a center position of the burst cutting area.

4. The optical disk apparatus according to claim 2, wherein the first layer is provided at the lowest layer in the multilayer disk.

5. An optical disk apparatus comprising:
a reading unit configured to read an address corresponding to a position of beam spot provided on a first layer of a multilayer disk;
a calculating unit configured to calculate, from the address corresponding to the position of beam spot, a seeking amount in making an access to a burst cutting area formed on the multilayer disk;
a first movement unit configured to move the position of beam spot in accordance with the seeking amount calculated by the calculating unit; and
a second movement unit configured to move the position of beam spot to a layer of the multilayer disk which is different from the first layer of the multilayer disk.

6. The optical disk apparatus according to claim 5, wherein the first layer is provided at the lowest layer in the multilayer disk.

7. The optical disk apparatus according to claim 5, wherein the second movement unit moves the position of beam spot to the layer different from the first layer after the first movement unit moves the position of beam spot in accordance with the seeking amount calculated by the calculating unit.

8. The optical disk apparatus according to claim 5, wherein the first movement unit moves the position of beam spot in accordance with the seeking amount calculated by the calculating unit after the second movement unit moves the position of beam spot to the layer different from the first layer.

9. The optical disk apparatus according to claim 5, wherein the calculating unit calculates, from the address read by the reading unit, the seeking amount in making the access to a center position of the burst cutting area.

10. An optical disk reproduction method for an optical disk apparatus, comprising:
reading an address corresponding to a position of beam spot provided on a first layer of a multilayer disk;
calculating, from the address corresponding to the position of beam spot, a seeking amount in making an access to a burst cutting area formed on the multilayer disk;
moving the position of beam spot in accordance with the seeking amount calculated by the calculating unit; and
moving the position of beam spot to a layer of the multilayer disk which is different from the first layer of the multilayer disk.

11. The optical disk apparatus according to claim 10, wherein the second movement unit moves the position of beam spot to the layer different from the first layer after the first movement unit moves the position of beam spot in accordance with the seeking amount calculated by the calculating unit.

12. The optical disk apparatus according to claim 10, wherein the first movement unit moves the position of beam spot in accordance with the seeking amount calculated by the calculating unit after the second movement unit moves the position of beam spot to the layer different from the first layer.

13. The optical disk apparatus according to claim 10, wherein the calculating unit calculates, from the address read by the reading unit, the seeking amount in making the access to a center position of the burst cutting area.
